(19) United States
(12) Patent Application Publication
(10) Pub. No.: US 2011/0274263 A1
(43) Pub. Date: Nov. 10, 2011

(54) VOICEMAIL APPLICATION

(75) Inventors: Artur TYLOCH, Warsaw (PL); Istvan NAGY, Budapest (HU); Dmytro ZAYATS, Arlington Heights, IL (US); Attila INCZE, Budapest (HU); Naheed VORA, Santa Clara, CA (US); Maarten ECTORS, Madrid (ES)

(73) Assignee: NOKIA SIEMENS NETWORKS OY, Espoo (FI)

(21) Appl. No.: 12/776,808

(22) Filed: May 10, 2010

(51) Int. Cl. H04M 3/42

(52) U.S. Cl. 379/211.01

(57) ABSTRACT

An application is described, which application detects that a communication device of a called party is not accepting a call from a calling party and initiates a voicemail application in response to the detecting step. The voicemail application includes a plurality of voicemail modules, each of which is a complete and functional voicemail application. The initiation of the voicemail application includes selecting one of said plurality of possible voicemail modules for use, for example on the basis of the identity (or some other characteristic) of the calling party and/or the identity (or some other characteristic) of the called party.

The present invention is directed to a voicemail application.

Voicemail applications are well known in the field of telecommunications. Voicemail applications allow an incoming call to be diverted to a voicemail program to enable the calling party to leave a message. The calling party may be diverted to voicemail, for example, because the called party is unavailable or because the called party chooses not to accept the incoming call.

Voicemail applications are typically provided by telecommunications operators. Such operators provide voicemail services for large numbers of customers. Such services cannot readily be customised by end users. Typically, a voicemail service allows an end user to record a message to be played to the calling party asking them to leave a message, but does not allow any further customization.

Thus, existing voicemail services lack flexibility and cannot be readily modified by end users.

The present invention seeks to address at least some of the problems outlined above.

The invention provides a method (of using a voicemail application) comprising: detecting that a communication device of a called party is not accepting (or is not able to accept) a call from a calling party; and initiating a voicemail application in response to the detecting step, wherein initiating said voicemail application includes the selection of one of a plurality of available voicemail modules of the voicemail application. The initiated voicemail application is not typically the voicemail service provided by the operator. Each voicemail module is typically a complete, functioning voicemail application. Accordingly, the voicemail application can provide a plurality a complete, functioning voicemail module, wherein one of those modules is selected for use each time the voicemail application is invoked.

The invention also provides an apparatus, such as a server (e.g. a SIP server), the apparatus comprising: a first input for detecting that a mobile communication device of a called party is not accepting a call from a calling party; and a first processor adapted to initiate a voicemail application in response to said detection, wherein the processor is adapted to select one of a plurality of available voicemail modules of said voicemail application.

Accordingly, the present invention can detect that a communication device of a called party is not accepting a call from a calling party and initiate a voicemail application in response to the detecting step. The voicemail application includes a plurality of voicemail modules, each of which is typically a complete and functional voicemail application. The initiation of the voicemail application includes selecting one of said plurality of possible voicemail modules for use, for example on the basis of the identity (or some other characteristic) of the calling party and/or the identity (or some other characteristic) of the called party. Thus, the present invention provides a great deal of flexibility.

The said one of said plurality of available voicemail modules selected in said selecting step may be dependent on a characteristic (such as identity, location or presence information) of the calling party. The said one of said plurality of available voicemail modules selected in said selecting step may be dependent on a characteristic (such as identity, location or presence information) of the called party. In some forms of the invention, selection step may make use of characteristics of both the calling party and the called party.

The selection step may combine more that one characteristic of the calling party and/or the called party. By way of example, a called party who is on holiday and receives a call from a work colleague may use a first voicemail application, but the same called party on holiday receiving a call from a personal friend may activate a second voicemail application. Such a procedure can readily be implemented by the present invention.

The selection step may be based on criteria unrelated to characteristics of the calling party and the called party (e.g. time of day). This may be instead of, or in addition to, the use of criteria related to characteristics of the calling party and/or the called party.

One or more additional voicemail modules may be added to said plurality of available voicemail modules. For example, a voicemail service can be bought. The ability to buy and sell voicemail modules greatly increases the flexibility of the present invention, particularly for users who may have difficulty in generating their own voicemail applications.

One or more of said voicemail modules may be modifiable by the user.

One or more of said voicemail modules may be provided by the called party. For example, a user may design and/or implement a voicemail module (e.g. a single module, multiple modules, or all of their voicemail modules). By way of example, the drag and drop method described in this specification could be used to generate one or more voicemail modules.

The communication device of the called party may be a mobile communication device or a fixed line device. The communication device of the calling party may be a mobile communication device or a fixed line device.

The step of detecting that a communication device of a called party is not accepting a call from a calling party may comprise receiving a call divert message from a telecommunications operator for the called party.

The present invention may be implemented in any of a number of locations. For example, the apparatus of the invention could form a part of the mobile communication device of the called party. Alternatively, the apparatus of the invention could form a part of an operator providing telecommunications services to said called party.

The apparatus of the invention may include a second input and a second output for communicating with the called party and/or an operator providing telecommunications service to said called party. Thus, the apparatus may be physically and/or logically distinct from the operator and the called party.

The present invention further provides a voicemail application comprising: a first processor adapted to detect that a communication device of a called party is not accepting (or is not able to accept) a call from a calling party; and a second processor (which may be same physical processor as the first processor) adapted to initiate a voicemail application in response to the detecting step, wherein initiating said voicemail application includes the selection of one of a plurality of available voicemail modules of the voicemail application.

The present invention yet further provides a computer program comprising: code (or some other means) for detecting that a communication device of a called party is not accepting (or is not able to accept) a call from a calling party; and code (or some other means) for initiating a voicemail application in response to the detecting step, wherein initiating said voicemail application includes the selection of one of a plurality of available voicemail modules of the voicemail application. The computer program may be a computer program product comprising a computer-readable medium bearing computer program code embodied therein for use with a computer.

Exemplary embodiments of the invention are described below, by way of example only, with reference to the following numbered schematic drawings.

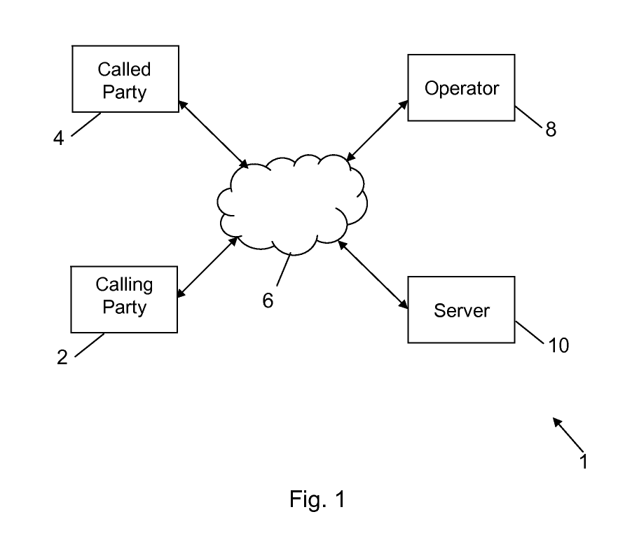

FIG. 1 is a block diagram of an exemplary system in accordance with an aspect of the present invention.

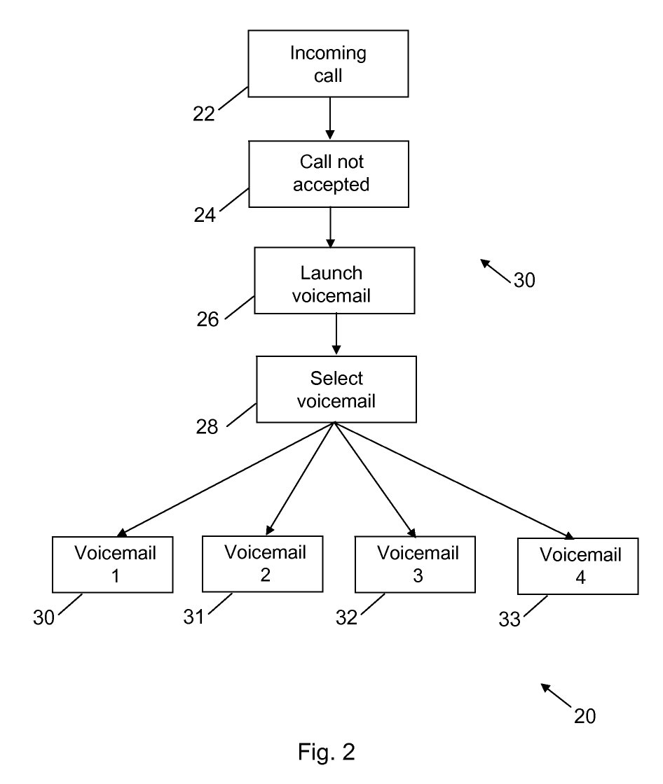

FIG. 2 is a flow chart showing an algorithm in accordance with an aspect of the present invention.

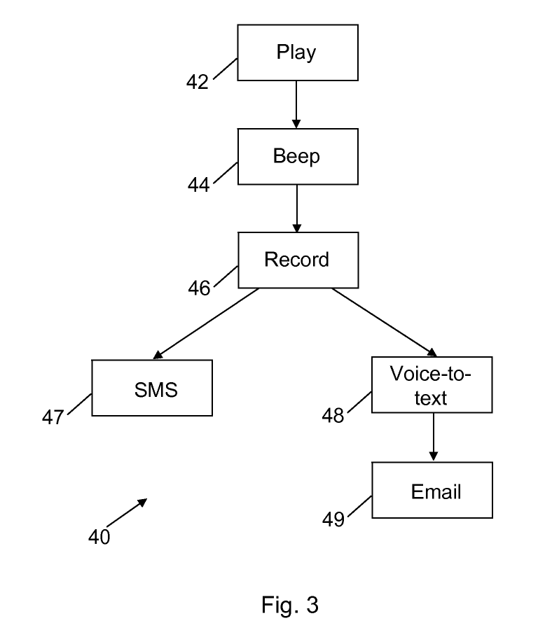

FIG. 3 is a flow chart showing an algorithm in accordance with an aspect of the present application.

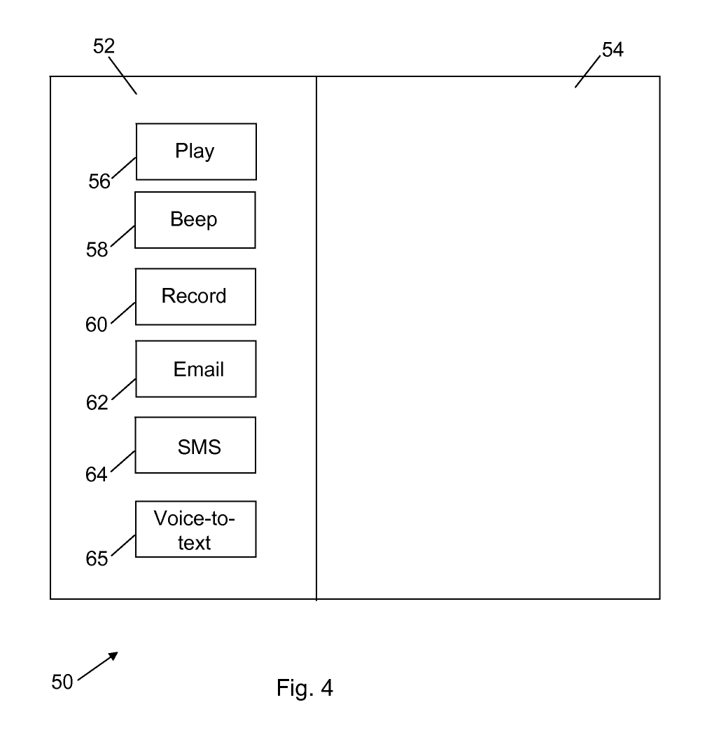

FIG. 4 shows an exemplary graphical user interface for a voicemail application generator.

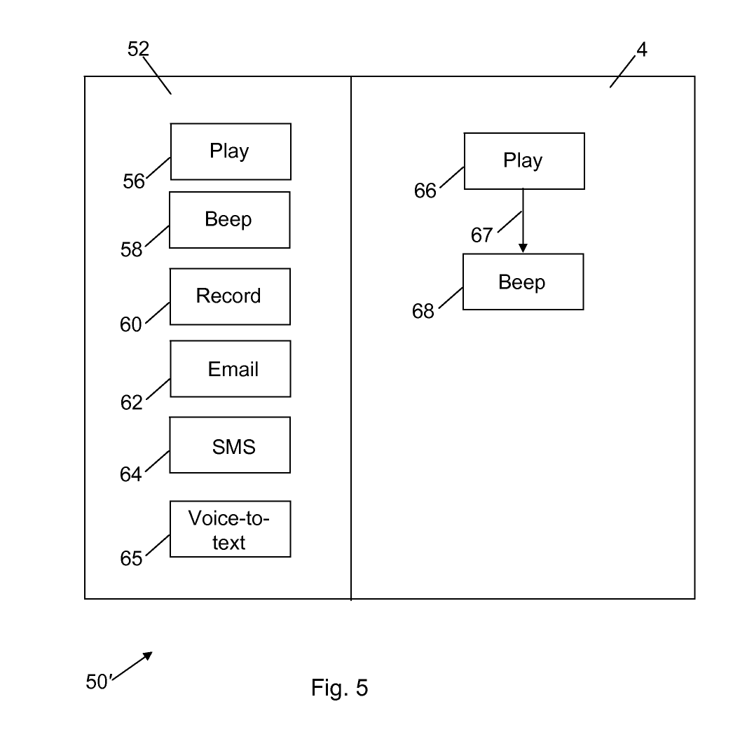

FIG. 5 shows the graphical use interface of FIG. 4 as used to generate a part of a voicemail application.

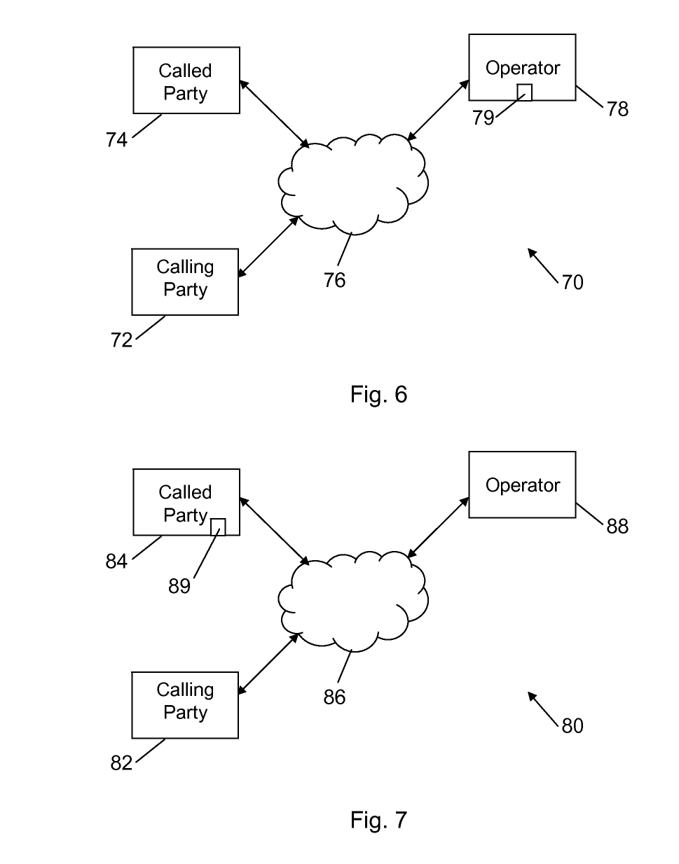

FIG. 6 is a block diagram of an exemplary system in accordance with an aspect of the present invention.

FIG. 7 is a block diagram of an exemplary system in accordance with an aspect of the present invention.

FIG. 1 shows an exemplary system, indicated generally by the reference numeral 1, in accordance with an aspect of the present invention. The system 1 comprises a communication device of a calling party 2, a communication device of a called party 4, a telecommunications network 6, a telecommunications operator 8 and a server 10. As described below, the server 10 provides one or more voicemail applications. The calling party 2 uses the telecommunications network 6 to attempt to call the called party 4.

The calling party 2 and/or the called party 4 may be implementing using a mobile communication device. The calling party 2 and/or the called party 4 may be implementing using a fixed-line communication device. The network 6 may be a mobile communications network and/or a fixed-line network. The operator 8 may be a mobile operator and/or a fixed-line operator.

FIG. 2 is a flow chart showing an algorithm, indicated generally by the reference numeral 20, in accordance with an aspect of the present invention. The algorithm 20 starts at step 22 where a call is made (or is attempted to be made) from the calling party 2 to the called party 4.

Next, at step 24, an indication is given that the call will not be (or is not) accepted. This may, for example, be because the called party is unavailable (perhaps because the device is switched off). Alternatively, the called party may refuse to accept the call. In any event, at step 24, the called party does not answer the call. This step usually triggers the activation of a voicemail service of the operator 8.

Next, at step 26, the voicemail application 10 is used to replace (or possibly work alongside) the normal voicemail service provided by the operator 8.

The application 10 may monitor communications sent to and/or from the mobile communication device of the called party 4. In this way, the application 10 can determine when the voicemail service should be initiated. Typically, the operator 8 implements voicemail services by diverting calls to its own voicemail service. This functionality can be used to arrange for the diversion to be made to the voicemail service provided by the server 10 rather that to the voicemail service provided by the operator 8. In one form of the invention, the called party 4 needs to instruct the operator (in advance) to redirect voicemail services to the server 10. Thus, the server 10 may simply await an indication of the operator 8 that a voicemail application should be initiated.

In one embodiment of the invention, the application 10 is implemented using a session initiation protocol (SIP) server.

The algorithm 20 proceeds to step 28 where a service logic (provided by the application 10) determines which of a number of voicemail services available to the voicemail application 10 should be used. In the exemplary algorithm 20, a first voicemail service 30, a second voicemail service 31, a third voicemail service 32 and a fourth voicemail server 33 are provided. Of course, more or fewer than four voicemail services could be provided.

In one form of the invention, the identity of the calling party 2 and/or the identity of the called party 4 may be used to select the voicemail application that should be used. For example, different voicemail accounts may be setup for different calling parties, or different classes of calling parties. Thus, a called party's wife may be diverted to the first voicemail application 30, the called party's personal friends may be diverted to the second voicemail application 31 and the called party's work colleagues may be diverted to the third voicemail application 32. All other callers may be diverted to the fourth voicemail application 33 (which functions as a default voicemail application).

Alternatively, or in addition, to user the calling party's identity to select an appropriate voicemail application, the called party's presence status may be used. For example, if the called party's presence status is “in a meeting”, then a voicemail application relevant to that status may be selected. Such an application may indicate that the called party is temporarily unavailable, but should be available soon. If the called party's presence status is “on vacation” and the calling party is a work colleague, the selection voicemail application might suggest that the calling party contacts one of the called party's colleagues for further assistance. If the called party's presence status is “on vacation” and the calling party is a personal friend, then an appropriate voicemail application could be selected indicating that the called party is on vacation but he can be contacted at a particular hotel in cases of emergency.

Of course, other selection mechanism, making use of one or more selection criteria, could be provided. For example, the location of the calling party and/or the called party or the time of day (alone or with other criteria) could also be used for making selection decisions. The skilled person will be able to think of many suitable selection algorithms.

One of the voicemail services 30, 31, 32 and 33 may be designated as a default voicemail service (e.g. the fourth voicemail application in the first example given above). Thus, if the selection step 28 does not determine that one of the other voicemail services should be selected, then the default service is used. The default service might typically be used if one or more of the calling party 2 and the called party 4 does not have a specific voicemail application assigned to it.

FIG. 3 is a flow chart showing an algorithm, indicated generally by the reference numeral 40, in accordance with an aspect of the present application. The flow chart 40 shows an exemplary voicemail application that might be provided by the voicemail application 10.

The algorithm 40 starts at step 42, where a message is played. The message might ask the calling party to leave a message. The message played at the step 42 may be provide as an audio file. The algorithm 40 may provide a file location for the audio file and, in some forms of the invention, the called party 4 (or a third party) may be able to change the file location of the audio file in order to change the message that is played. Alternatively, or in addition, the called party or a third party may be able to modify or replace the audio file itself.

Next, at step 44, a “beep” message is played. The beep may simply be an audible beep played to the calling party to indicate that a message should now be left. As with the step 42, the step 44 may include a reference to an audio file providing the beep message. As with the message played at step 42, the beep message could be modified, or the file location for the beep message could be modified.

The algorithm 40 then moves to step 46, which is a “record” step. At step 46, a message can be left by the calling party and that message is recorded.

Once the record step has been completed, the algorithm 40 divides in two, moving to both step 47 and 48.

At step 47 of the algorithm 40, an SMS message is sent to the called party informing them that a voicemail message has been left. The SMS message sent at step 47 might provide instructions of how the called party can retrieve the message. This branch of the algorithm 40 terminates once the step 47 has been completed.

At step 48 of the algorithm 40, a voice-to-text algorithm is applied to the message recorded at the record step 46 in order to transcribe any message left by the calling party. The algorithm 40 then moves to step 49, where the message transcribed at step 48 is placed into an email message, and that email message is sent to an email account of the called party. This branch of the algorithm 40 terminates once the step 49 has been completed.

The algorithm 40 is one of many voicemail algorithms that could be implemented by the voicemail application 10.

The voicemail applications 30, 31, 32 and 33 that are provided by the voicemail application at the server 10 may be implemented in many different ways. For example, one or more of the voicemail applications might be implemented by being coded by a computer programmer. Alternatively, one or more of the voicemail applications might be purchased by an end user. In some forms of the invention, the entire voicemail application may be bought. In other forms of the invention, one or more of the voicemail applications 30, 31, 32 and 33 may be bought, with other applications being provided or obtained in some other way. Thus, the present invention can provide a great deal of flexibility.

In a further alternative, one or more of the voicemail applications 30, 31, 32 and 33 may be generated by an end user (or a third party) as described below with reference to FIGS. 4 and 5.

FIG. 4 shows an exemplary graphical user interface for a voicemail application generator, indicated generally by the reference numeral 50, in accordance with an aspect of the present invention.

The user interface 50 comprises a first panel 52 and a second panel 54. The first panel 52 includes a number of elements that can be used to define a voicemail application. The second panel 54 is used to define and display the voicemail application (as discussed further below).

The elements shown in the panel 52 of FIG. 4 are a play icon 56, a beep icon 58, a record icon 60, an Email icon 62, an SMS icon 64 and a voice-to-text icon 65. Many other icons could be provided, including an Instant Messaging icon or a text-to-voice icon. Icons may be provided to forward messages to a user's social network application. Icons could be provided that relate to non-voicemail related applications, such as a location-based-services module. The skilled person will be able to think of many more such icons that could be provided.

The icons shown in the panel 52 are building blocks that can be used to build a voicemail application. In order to define a voicemail application, a user selects one of the icons and places an instance of that icon in the panel 54. The user places several icons in the panel and the joins the icons together (using an arrow) to generate an algorithm.

By way of example, FIG. 5 shows a graphical user interface indicated generally by the reference numeral 50′. The graphical user interface 50′ is the same as the graphical user interface 50, but additionally includes part of an exemplary voicemail application in the second panel 54. Thus, the graphical user interface 50′ includes the icons 56, 58, 60, 62, 64 and 65 in the first panel 52. In addition, the graphical user interface 50′ includes (in the second panel 54) an instance of the play icon 56 (shown as icon 66 in the second panel) and an instance of the beep icon 58 (shown as icon 68 in the second panel 54). The play icon 66 and beep icon 68 are joined by an arrow 67 that indicates that the algorithm shown starts at icon 66 and then moves to icon 68.

In this way, the start of the algorithm 40 described above with reference to FIG. 3 has been generated.

Each of the icons shown in the first panel 52 of the user interface may have computer code associated with it. The computer code may be a routine that can be called to implement the functionality of the module. Accordingly, when the user interface 50 is used to generate a voicemail application, the voicemail application can be implemented by calling the routine associated with the relevant icon when indicated by the user-defined application.

FIGS. 6 and 7 are block diagrams of an exemplary systems in accordance with an aspect of the present invention. The systems shown in FIGS. 6 and 7 are similar to the system 1 described above, but the location of the voicemail application is different in each case.

FIG. 6 shows a system, indicated generally by the reference numeral 70 comprising a communication device of a calling party 72, a communication device of a called party 74, a telecommunications network 76 and a telecommunications operator 78. The telecommunications operator includes a voicemail application 79 that is similar to the voicemail application 10 described above. Thus, the system 70 differs from the system 1 in that the voicemail application is provided as part of the operator, rather that as a separate module provided by the server 10.

FIG. 7 shows a system, indicated generally by the reference numeral 80 comprising a communication device of a calling party 82, a communication device of a called party 84, a telecommunications network 86 and a telecommunications operator 88. The called party includes a voicemail application 89 that is similar to the voicemail applications 10 and 78 described above. Thus, the system 80 differs from the systems 1 and 70 in that the voicemail application is provided as part of the called party.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A method comprising:
detecting that a communication device of a called party is not accepting a call from a calling party; and
initiating a voicemail application in response to the detecting step, wherein initiating said voicemail application includes the selection of one of a plurality of available voicemail modules of the voicemail application.

2. A method as claimed in claim 1, wherein said one of said plurality of available voicemail modules selected in said selecting step is dependent on the identity of the calling party.

3. A method as claimed in claim 1, wherein said one of said plurality of available voicemail modules selected in said selecting step is dependent on the presence status of the called party.

4. A method as claimed in claim 1, wherein one or more additional voicemail modules may be added to said plurality of available voicemail modules.

5. A method as claimed in claim 1, wherein one or more of said voicemail modules are modifiable by the user.

6. A method as claimed in claim 1, wherein one or more of said voicemail modules are provided by the called party.

7. A method as claimed in claim 1, wherein the step of detecting that a communication device of a called party is not accepting a call from a calling party comprises receiving a call divert message from a telecommunications operator for the called party.

8. An apparatus comprising:
a first input for detecting that a communication device of a called party is not accepting a call from a calling party; and
a first processor adapted to initiate a voicemail application in response to said detection, wherein the processor is adapted to select one of a plurality of available voicemail modules of said voicemail application.

9. An apparatus as claimed in claim 8, further comprising a first output for communicating with said calling party.

10. An apparatus as claimed in claim 8, wherein the apparatus forms a part of the communication device of the called party.

11. An apparatus as claimed in claim 8, wherein the apparatus forms a part of an operator providing telecommunications services to said called party.

12. An apparatus as claimed in claim 8, further comprising a second input and a second output for communicating with the called party and/or an operator providing telecommunications service to said called party.

13. An apparatus as claimed in claim 8, further comprising a third input for receiving an additional voicemail module for inclusion in said voicemail application.

14. An apparatus as claimed in claim 8, further comprising a second processor for enabling a user to modify one or more of said voicemail modules.

15. A voicemail application comprising:
a first processor adapted to detect that a communication device of a called party is not accepting a call from a calling party; and
a second processor adapted to initiate a voicemail application in response to the detecting step, wherein initiating said voicemail application includes the selection of one of a plurality of available voicemail modules of the voicemail application.

16. A voicemail application as claimed in claim 15, wherein said one of said plurality of available voicemail modules selected in said selecting step is dependent on one or more characteristics of the calling party and/or the called party.

17. A computer program product comprising:
means for detecting that a communication device of a called party is not accepting a call from a calling party; and
means for initiating a voicemail application in response to the detecting step, wherein initiating said voicemail application includes the selection of one of a plurality of available voicemail modules of the voicemail application.
